(19) United States
(12) Patent Application Publication
(10) Pub. No.: US 2020/0233460 A1
(43) Pub. Date: Jul. 23, 2020

(54) ELECTRONIC DEVICE

(71) Applicant: FUJITSU CLIENT COMPUTING LIMITED, Kanagawa (JP)

(72) Inventor: Takashi Abe, Kawasaki (JP)

(73) Assignee: FUJITSU CLIENT COMPUTING LIMITED, Kanagawa (JP)

(21) Appl. No.: 16/690,297

(22) Filed: Nov. 21, 2019

(30) Foreign Application Priority Data
Jan. 18, 2019 (JP) 2019-006722

(51) Int. Cl. G06F 1/16

(52) U.S. Cl. CPC G06F 1/1637; G06F 1/1616

(57) ABSTRACT

An electronic device includes: a display, a support member, and a fixing member. The display includes: a first face, a second face opposite to the first face, and a lateral face extending between the first face and the second face. The support member includes a support face on which the first face is disposed, and a projection. The fixing member includes a first fixing part fixed to at least one of the second face and the lateral face, and a second fixing part that faces the projection along the first face and is fixed to the support member.

### CROSS-REFERENCE TO RELATED APPLICATIONS

This application is based upon and claims the benefit of priority from Japanese Patent Application No. 2019-006722, filed Jan. 18, 2019, the entire contents of which are incorporated herein by reference.

### FIELD

Embodiments described herein relate generally to an electronic device.

### BACKGROUND

Conventionally, electronic devices including a display device and a support member on which the display device is secured are known.

It is beneficial to provide such an electronic device of a novel structure which includes a display device attached to a support member in accurate position, and can prevent the display device from being damaged at the time of attaching the display device to the support member, for example.

### SUMMARY

According to one aspect, in general, an electronic device includes a display including a first face, a second face opposite to the first face, and a lateral face extending between the first face and the second face; a support member including a support face on which the first face is placed, and a projection located with spacing with respect to the lateral face along the first face, the projection extending from the support face in a direction intersecting the support face; and a fixing member including a first fixing part fixed to at least one of the second face and the lateral face, and a second fixing part that faces the projection along the first face, and is fixed to the support member.

### BRIEF DESCRIPTION OF THE DRAWINGS

FIG. 1 is an exemplary perspective view of an electronic device in an opened state according to an embodiment, as viewed from the front side;

FIG. 2 is an exemplary exploded perspective view of a touch panel and a front cover in a second module in the embodiment, as viewed from the front side;

FIG. 3 is an exemplary perspective view of the rear side of the second module with a rear cover removed in the embodiment;

FIG. 4 is an exploded perspective view of the second module illustrated in FIG. 3;

FIG. 5 is an exemplary perspective view of the rear side of a display unit in the embodiment;

FIG. 6 is an exemplary partial enlarged view of a VI part in FIG. 3;

FIG. 7 is a section view of FIG. 6 along VII to VII line;

FIG. 8 is an exemplary exploded perspective view of the rear side of a display device and a fixing member in the second module in the embodiment; and

FIG. 9 is an exemplary partial enlarged view of a IX part in FIG. 3.

### DETAILED DESCRIPTION

An exemplary embodiment will be described below. Configurations or structures of the embodiment as well as operations and effects attained by the configurations or structures are merely exemplary. The embodiment may be achieved by configurations or structures other than those disclosed herein. The embodiment can attain at least one of various effects including derivative effects obtained by the configurations or structures.

Throughout this disclosure, ordinal numbers are used to distinguish parts, elements, and components, members, positions, locations, directions, and else and are not intended to indicate order or priority.

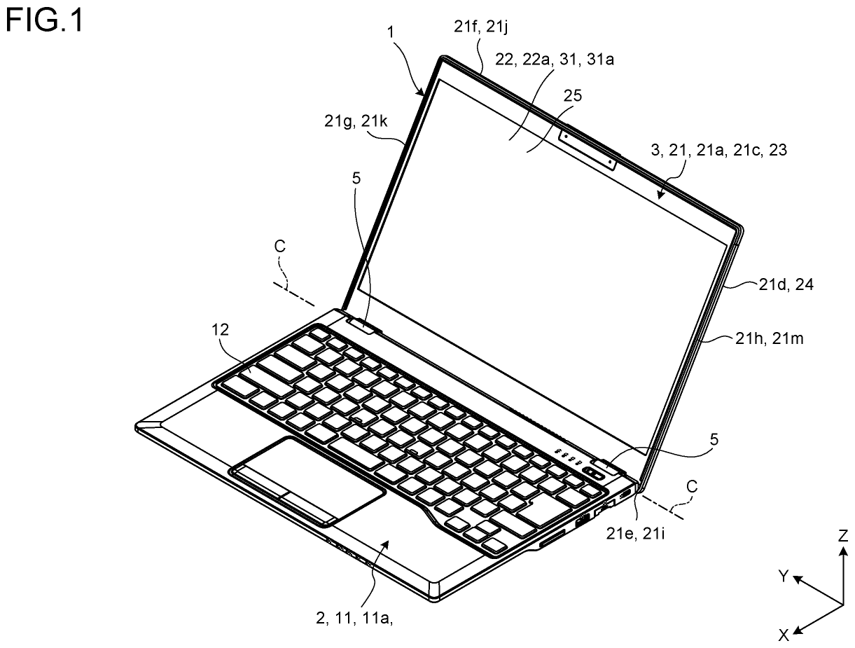

FIG. 1 is an exemplary perspective view of the front side of an electronic device 1 of the embodiment, with a second module 3 being in an opened state.

As illustrated in FIG. 1, the electronic device 1 serves as a notebook or clamshell personal computer, for example, and includes a first module 2 and the second module 3. The first module 2 is placed on a mount, such as a desk, a rack, a stand, or a shelf, for example. The second module 3 is rotatably supported by the first module 2 about an axis of rotation C with respect to the first module 2, and is movable between an opened position (FIG. 1) and a closed position (not illustrated). Specifically, the second module 3 is coupled to the first module 2 via hinges 5. The electronic device 1 is not limited to this example, and may be a desktop personal computer, a slate or tablet personal computer, a smartphone, a cellular phone, a video display device, a television receiver, or a game machine, for example.

In the present embodiment, three mutually orthogonal directions are defined for the sake of convenience. An X direction is along the depth (fore to aft, short side) of the first module 2, a Y direction is along the width (in horizontal or longitudinal direction) of the first module 2, and a Z direction is along the height (top to bottom) of the first module 2. In the following, the X direction is also referred to as frontward, a direction opposite to the X direction as rearward, the Y direction as leftward, a direction opposite to the Y direction as rightward, the Z direction as upward, and a direction opposite to the Z direction as downward.

The first module 2 include a first housing 11 and a keyboard 12 supported by the first housing 11. The keyboard 12 is supported by the first housing 11 in an operable state from above. The first housing 11 houses therein a substrate (not illustrated). A plurality of electronic components (not illustrated) including a central processing unit (CPU), a read-only memory (ROM), and a random access memory (RAM) are mounted on the substrate. Wiring and the electronic components mounted on the substrate constitute at least part of an electronic circuit of the electronic device 1.

The second module 3 includes a second housing 21, a display unit 22, and a touch panel 25. The display unit 22 is supported by the second housing 21 with a display screen 22a viewable from the front side. The touch panel 25 is supported by the second housing 21 while covering the display screen 22a of the display unit 22.

In the opened state of the second module 3 (the second housing 21) in FIG. 1, a top face 11a of the first housing 11 and the keyboard 12 do not oppose a front face 21a of the second housing 21 and the display screen 22a of the display unit 22. The top face 11a of the first housing 11, the keyboard 12, the front face 21a of the second housing 21, and the display screen 22a of the display unit 22 are exposed. The front face 21a and a rear face 21b of the second housing 21 are directed frontward and rearward, respectively.

In the closed state (not illustrated) of the second module 3 (the second housing 21), the top face 11a of the first housing 11 and the keyboard 12 oppose the front face 21a of the second housing 21 and the display screen 22a of the display unit 22.

Next, the second module 3 will be described in detail.

As illustrated in FIG. 1, the second housing 21 has a flat, rectangular parallelepiped shape. The second housing 21 includes a plurality of walls such as a front wall 21c, a rear wall 21d, a bottom wall 21e, a top wall 21f, a left wall 21g, and a right wall 21h, for example.

The front wall 21c includes the front face 21a, and the rear wall 21d includes the rear face 21b.

The bottom wall 21e and the top wall 21f serve as a bottom end 21i and a top end 21j of the second housing 21 respectively. The top end 21j is spaced apart from the axis of rotation C. The bottom end 21i is closer to the axis of rotation C with respect to the top end 21j.

The left wall 21g and the right wall 21h serve as a left end 21k and a right end 21m of the second housing 21, respectively.

The second housing 21 is made of a combination of two or more members including a front cover 23 and a rear cover 24. The front cover 23 has a rectangular frame shape, including part of the front wall 21c. The rear cover 24 includes at least the rear wall 21d. The front cover 23 and the rear cover 24 are joined together with fasteners or screws, for example.

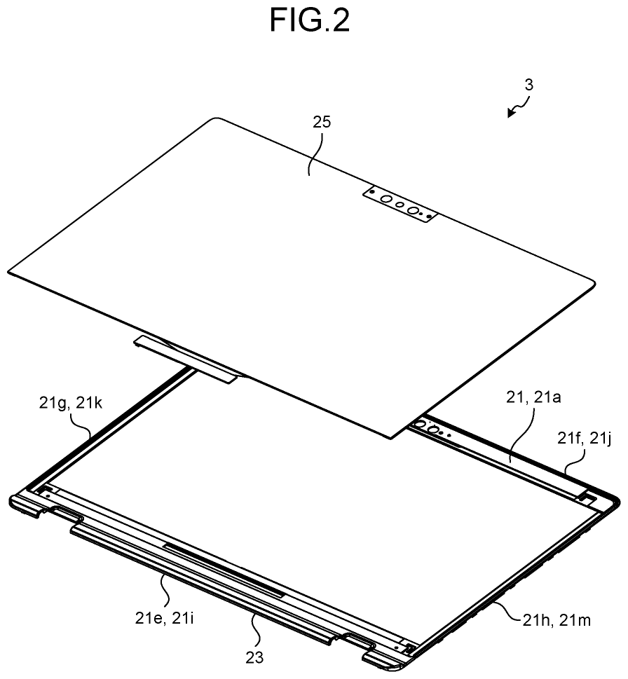

FIG. 2 is an exemplary exploded perspective view of the touch panel 25 and the front cover 23 in the second module 3 in the embodiment, as viewed from the front side.

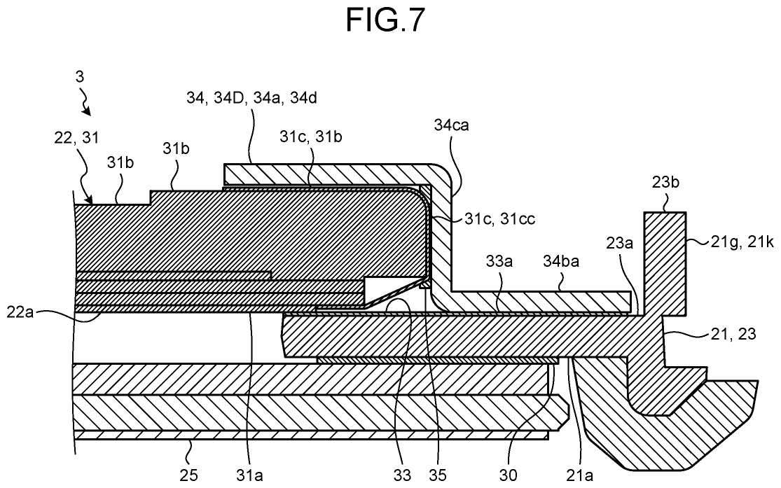

As illustrated in FIG. 1 and FIG. 2, the touch panel 25 is fixed to the front face 21a. The touch panel 25 is bonded to the front face 21a of the front cover 23 with a double-faced adhesive tape 30 (FIG. 7), for example. The touch panel 25 has a flat, rectangular parallelepiped shape.

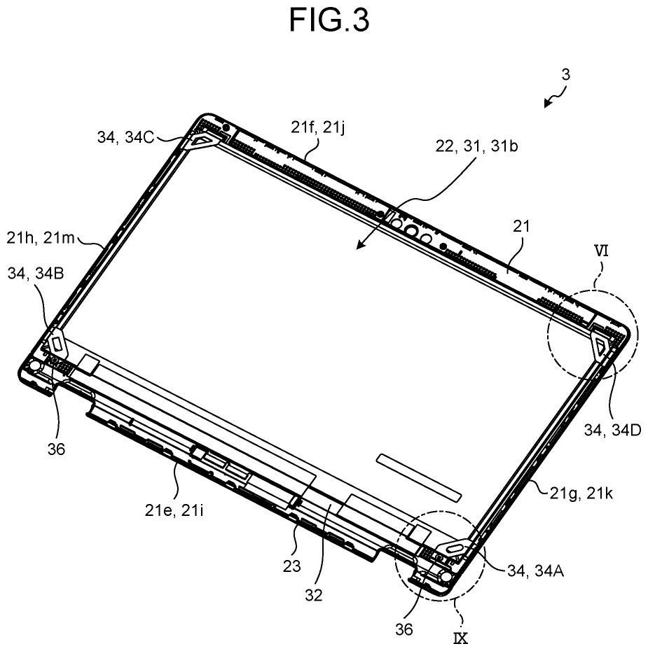

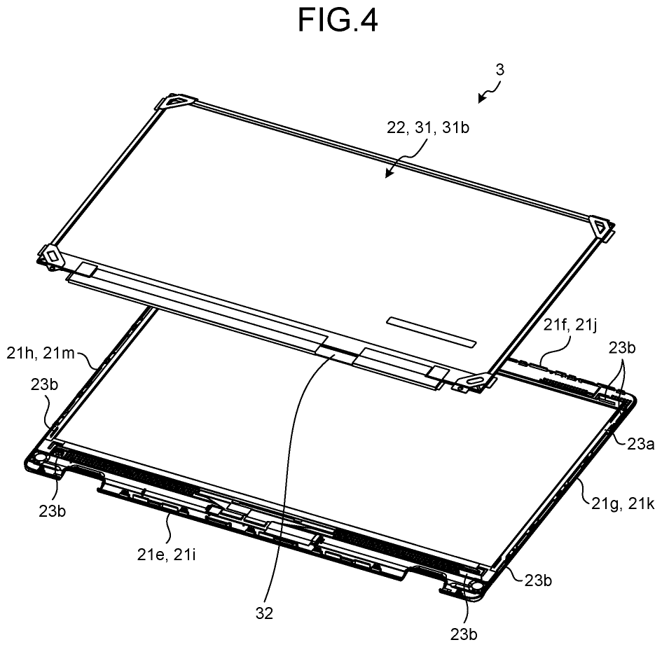

FIG. 3 is an exemplary perspective view of the rear side of the second module 3 with the rear cover 24 removed in the embodiment. FIG. 4 is an exploded perspective view of the second module 3 illustrated in FIG. 3.

As illustrated in FIG. 3 and FIG. 4, the second module 3 is located opposite the front face 21a of the front cover 23, and is fixed to a support face 23a of the front cover 23. The support face 23a of the front cover 23 is opposite to the front face 21a of the front cover 23.

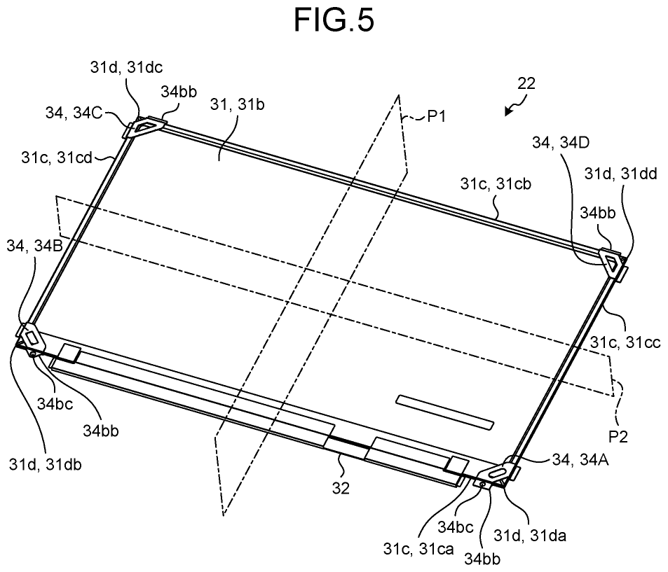

FIG. 5 is an exemplary perspective view of the rear side of the display unit 22 in the embodiment.

As illustrated in FIG. 5, the display unit 22 includes a display 31 and a substrate 32 for controlling the display 31.

The display 31 is a liquid crystal display, for example. However, the display 31 is not limited to a liquid crystal display. The display 31 may be an organic electroluminescent (EL) display, for example.

The display 31 has a flat, rectangular parallelepiped shape. As illustrated in FIG. 1 and FIG. 5, the display 31 includes a first face 31a (FIG. 1), a second face 31b opposite the first face 31a (FIG. 5), and a plurality of lateral faces 31c extending between the first face 31a and the second face 31b (FIG. 5). The first face 31a includes the display screen 22a. The lateral faces 31c include a lower lateral face 31ca, an upper lateral face 31cb, a left lateral face 31cc, and a right lateral face 31cd. The lower lateral face 31ca serves as a bottom end or bottom side of the display 31, the upper lateral face 31cb serves as a top end or top side of the display 31, the left lateral face 31cc serves as a left end or left side of the display 31, and the right lateral face 31cd serves as a right end or right side of the display 31. The lateral faces 31c are connected to one another.

As illustrated in FIG. 5, the display 31 has four corners 31da to 31dd. The corner 31da is defined by the intersection between the lower lateral face 31ca and the left lateral face 31cc. The corner 31db is defined by the intersection between the lower lateral face 31ca and the right lateral face 31cd. The corner 31dc is defined by the intersection between the right lateral face 31cd and the upper lateral face 31cb. The corner 31dd is defined by the intersection between the upper lateral face 31cb and the left lateral face 31cc. The four corners 31da to 31dd are referred to simply as corners 31d unless otherwise distinguished from one another.

The substrate 32 projects from the lower lateral face 31ca of the lateral faces 31c in a direction intersecting or orthogonal to the lower lateral face 31ca, i.e., oppositely to the upper lateral face 31cb. The horizontal width of the substrate 32 is smaller than that of the lower lateral face 31ca. The substrate 32 is spaced apart from the lateral ends of the lower lateral face 31ca, that is, the corners 31da and 31db. The substrate 32 is also referred to as a circuit board or a control board.

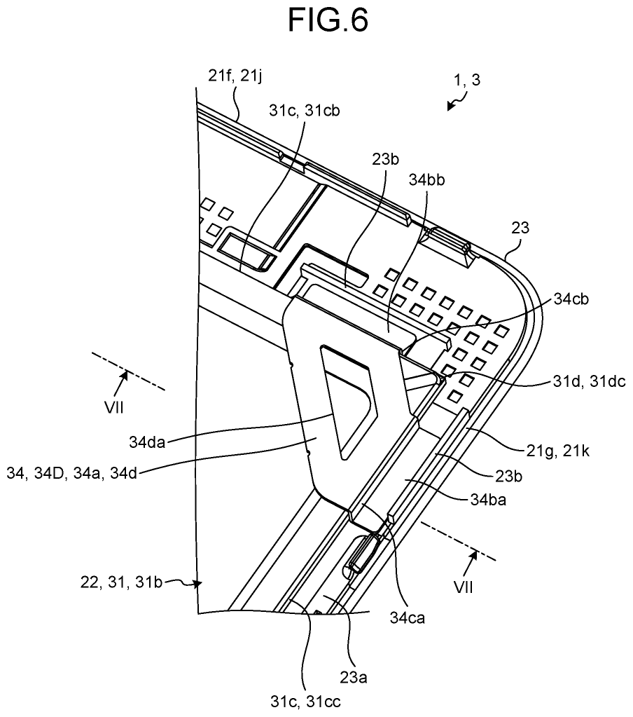

A fixation structure of the display 31 to the front cover 23 will be described next. FIG. 6 is an exemplary partial enlarged view of a VI part in FIG. 3. FIG. 7 is a section view of FIG. 6 along the VII-VII line.

As illustrated in FIG. 4 to FIG. 7, the support face 23a of the front cover 23 is provided with a plurality of libs 23b for positioning the display 31. The libs 23b are plate-like in shape. The libs 23b extend from the support face 23a in a direction intersecting the support face 23a, e.g., rearward. That is, the libs 23b project from the support face 23a in a direction intersecting the support face 23a. Two libs 23b are located in each of the corners 31d of the display 31. One of the two libs 23b in the corner 31d opposes, with spacing, one of the two lateral faces 31c defining the corner 31d, while the other of the two libs 23b opposes, with spacing, the other of the two lateral faces 31c defining the corner 31d. The libs 23b are exemplary projections. The libs 23b are also referred to as positioning members or protrusions or convexities.

The display 31 is fixed to the front cover 23 in an area inside the libs 23b with the first face 31a and the support face 23a of the front cover 23 placed on top of each other. As illustrated in FIG. 3 and FIG. 7, the display 31 is fixed to the support face 23a of the front cover 23 with a double-faced adhesive tape 33 (FIG. 7) and a plurality of fixing members 34.

As illustrated in FIG. 7, the double-faced adhesive tape 33 extends along the outer edge of the first face 31a of the display 31 between the first face 31a and the support face 23a of the front cover 23 to bond the first face 31a to the support face 23a. The double-faced adhesive tape 33 is provided with a projection 33a that extends on the support face 23a from the display 31 to outside. That is, the projection 33a projects from the display 31 to outside on the support face 23a. The projection 33a is also referred to as a convexity.

As illustrated in FIG. 5, the fixing members 34 include a fixing member 34A in the corner 31da of the display 31, a fixing member 34B in the corner 31db of the display 31, a fixing member 34C in the corner 31dc of the display 31, and a fixing member 34D in the corner 31dd of the display 31. The fixing members 34 all have the same structure, therefore, the fixing member 34D will be described in detail as a representative example.

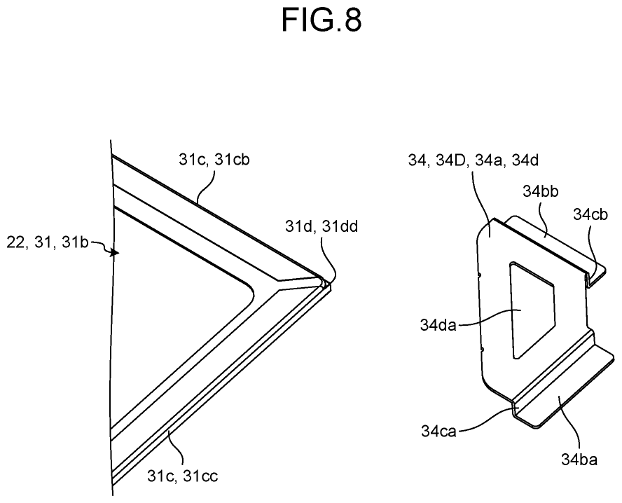

FIG. 8 is an exemplary exploded perspective view of the rear side of the display 31 and the fixing member 34D in the second module 3 in the embodiment.

As illustrated in FIG. 6 to FIG. 8, the fixing member 34D is made of a sheet metal member with a plurality of bent parts. The fixing member 34D is made from a metallic material, such as stainless steel and aluminum, for example. The fixing member 34D is also referred to as a fixing and reinforcing member or a plate-like member.

The fixing member 34D includes a first fixing part 34a and two second fixing parts 34ba and 34bb connected to the first fixing part 34a.

The first fixing part 34a includes two first covers 34ca and 34cb and a second cover 34d. The first covers 34ca and 34cb have a flat plate shape along the left lateral face 31cc and the upper lateral face 31cb, covering the left lateral face 31cc and the upper lateral face 31cb, respectively. The first covers 34ca and 34cb are bonded to the left lateral face 31cc and the upper lateral face 31cb with a double-faced adhesive tape 35 (FIG. 7). An adhesive agent may be used in place of the double-faced adhesive tape 35.

The second cover 34d has a flat plate shape along the second face 31b of the display 31, covering the second face 31b. There is a clearance between the second cover 34d and the second face 31b. The second cover 34d is located between the two first covers 34ca and 34cb to connect the two first covers 34ca and 34cb to each other. The second cover 34d is provided with a through hole 34da extending along the thickness. The second cover 34d may be provided with a cutout in place of the through hole 34da. The through hole 34da and the cutout are an exemplary opening.

The two second fixing parts 34ba and 34bb are attached to the two adjacent lateral faces 31c, i.e., the left lateral face 31cc and the upper lateral face 31cb, and connected to the first covers 34ca and 34cb of the first fixing part 34a, respectively. That is, the two second fixing parts 34ba and 34bb are connected to each other through the first fixing part 34a. The second fixing parts 34ba and 34bb have a flat plate shape along the support face 23a of the front cover 23. The second fixing parts 34ba and 34bb are placed on the support face 23a of the front cover 23, facing the libs 23b in directions along the first face 31a, that is, horizontally and vertically. There may be a clearance or no clearance between the second fixing parts 34ba and 34bb and the libs 23b. The second fixing parts 34ba and 34bb are fixed to the support face 23a of the front cover 23. The second fixing parts 34ba and 34bb are bonded to the support face 23a with the projection 33a of the double-faced adhesive tape 33.

As illustrated in FIG. 5, the fixing member 34C is symmetrical to the fixing member 34D about a plane P1 that passes the lateral center of the display 31 and is orthogonal to the width of the display 31.

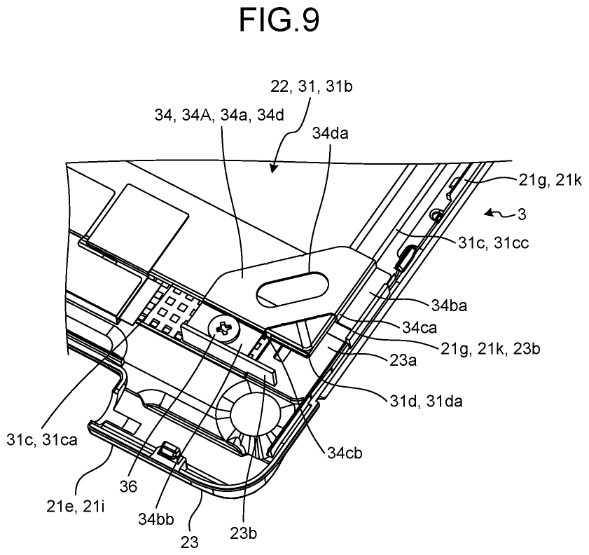

The fixing member 34A is symmetrical to the fixing member 34D about a plane P2 that passes the vertical center of the display 31 and is vertically orthogonal to the display 31 except for a part thereof. One of differences in the fixing member 34A from the fixing member 34D is in the second fixing part 34bb provided with a through hole 34bc along the thickness. FIG. 9 is an exemplary partial enlarged view of a IX part in FIG. 3. As illustrated in FIG. 9, the second fixing part 34bb of the fixing member 34A is fixed to the support face 23a of the front cover 23 with a screw 36 inserted into the through hole 34bc.

As illustrated in FIG. 5, the fixing member 34A is substantially symmetrical to the fixing member 34B about the plane P1. As with the fixing member 34A, the fixing member 34B is fixed to the support face 23a of the front cover 23 with a screw 36 inserted into the through hole 34bc.

An exemplary assembly or manufacturing method of the second module 3 having the above structure will be described. From the state of the front cover 23 and the touch panel 25 as illustrated in FIG. 2, the touch panel 25 is fixed to the front cover 23. The fixing members 34 are also fixed to the display 31 of the display unit 22 (FIG. 5). Subsequently, from the state of the front cover 23 and the display unit 22 as illustrated in FIG. 4, the display unit 22 is fixed to the front cover 23. The fixing members 34 and the display 31 can be positioned by allowing the fixing members 34 to be in contact with the libs 23b of the front cover 23 in directions along the first face 31a, that is, horizontally and vertically. Also, the fixing members 34 can function to prevent the outer periphery of the display 31 from running upon the libs 23b.

As described above, the electronic device 1 of the present embodiment includes the display 31, the front cover 23 (support member), and the fixing members 34. The display 31 includes the first face 31a, the second face 31b opposite to the first face 31a, and the lateral faces 31c extending between the first face 31a and the second face 31b (the lower lateral face 31ca, the upper lateral face 31cb, the left lateral face 31cc, the right lateral face 31cd). The front cover 23 includes the support face 23a on which the first face 31a is placed, and the libs 23b (projections) that are located with spacing with respect to the lateral faces 31c along the first face 31a and that extend from the support face 23a in the direction intersecting the support face 23a. The fixing members 34 each include the first fixing part 34a fixed to at least either of the second face 31b and the lateral faces 31c (the lateral faces 31c as an example), and the second fixing parts 34ba and 34bb connected to the first fixing part 34a, facing the libs 23b along the first face 31a, and fixed to the front cover 23.

By such a structure, the second fixing parts 34ba and 34bb of the fixing members 34 face the libs 23b of the front cover 23 along the first face 31a, which enables attachment of the display 31 to the front cover 23 with higher positional accuracy, for example. Additionally, the fixing members 34 work to prevent the outer periphery of the display 31 from running upon the libs 23b, for example. Thus, the display 31 can be prevented from being damaged such as scratches and cracks at the time of attaching the display 31 to the front cover 23. Further, owing to the fixing members 34 the second module 3 is improved in strength and stiffness.

In the present embodiment, the display 31 is fixed and bonded to the support face 23a with the fixing members 34 and the double-faced adhesive tape 33. Thus, the fixation strength of the display 31 with respect to the support face 23a is increased as compared with the display 31 fixed to the support face 23a with the double-faced adhesive tape 33 alone.

In the present embodiment, the first fixing part 34a includes the first covers 34ca and 34cb that are connected to the second fixing parts 34ba and 34bb to cover the lateral faces 31c, for example.

According to such a structure, the first covers 34ca and 34cb can restrict the display 31 from moving in the directions in which the lateral faces 31c face, for example.

In the present embodiment, the first fixing part 34a includes the second cover 34d that is connected to the first covers 34ca and 34cb to cover the second face 31b, for example.

According to such a structure, the second cover 34d can restrict the display 31 from moving in the direction in which the second face 31b faces, for example.

In the present embodiment, the display 31 includes the lateral faces 31c that are connected to one another, for example. The fixing members 34 each include the two second fixing parts 34ba and 34bb located on the two adjacent lateral faces 31c. The first fixing part 34a connects the two second fixing parts 34ba and 34bb to each other.

According to such a structure, the fixation strength of the display 31 is improved as compared with display 31 fixed with only one of the second fixing parts 34ba and 34bb, for example.

In the present embodiment, the fixing members 34A and 34B each include the second fixing part 34ba bonded to the support face 23a while the fixing members 34C and 34D each include the second fixing parts 34ba and 34bb bonded to the support face 23a, for example.

According to such a structure, the area for fixing the fixing members 34 to the support face 23a can be enlarged. Further, the one double-faced adhesive tape 33 with the projection 33a can work to secure both the display 31 and the fixing members 34 on the support face 23a of the front cover 23. In other words, it is possible to increase the area of the bonding surface of the double-faced adhesive tape 33 to fix the display 31 to the support face 23a.

In the present embodiment, the fixing members 34A and 34B each include the second fixing part 34bb fixed to the support face 23a with the screw 36, for example.

According to such a structure, fixation of the second fixing part 34bb with the screw 36 can improve the fixation strength of the display 31 to the front cover 23.

In the present embodiment, the display unit 22 includes the substrate 32 for controlling the display 31, for example. The display 31 includes the lateral faces 31c connected to one another. The substrate 32 projects from one of the lateral face 31c, i.e., the lower lateral face 31ca in the direction intersecting the lower lateral face 31ca. The second fixing parts 34bb of the fixing members 34A and 34B fixed to the support face 23a with the screws 36 are located between the lower lateral face 31ca and the opposing libs 23b.

According to such a structure, the second fixing parts 24bb of the fixing members 34A and 34B are located in spaces defined by the substrate 32 and the lower lateral face 31ca. This makes it possible to increase the second fixing parts 24bb and the screws 36 in size.

The above embodiment has described the example that the first fixing part 34a of the fixing members 34 is fixed to the lateral faces 31c between the second face 31b and the lateral faces 31c, however, the embodiment is not limited to such an example. The first fixing part 34a may be fixed to the second face 31b, for example. That is, the second cover 34d may be fixed to the second face 31b. Alternatively, the first fixing part 34a may be fixed to both the second face 31b and the lateral faces 31c. That is, the first covers 34ca and 34cb may be fixed to the lateral faces 31c, and the second cover 34d may be fixed to the second face 31b.

The shape of the fixing members 34 is not limited to the one disclosed in the embodiment. The fixing members 34 may not include the second cover 34d, for example. The first covers 34ca and 34cb may be, for example, tilted to the lateral faces 31c.

The number of the fixing members 34 is not limited to the one disclosed in the embodiment. The number of the fixing members 34 may be, for example, two in diagonal locations.

The above embodiment has described the libs 23b as exemplary projections, however, the embodiment is not limited to such an example. For example, the projections may be rod-like protrusions or walls other than the libs 23b.

The above embodiment has described the example that the display 31 includes the substrate 32, however, the embodiment is not limited to such an example. The display 31 may not include the substrate 32, for example. In this case, the first housing 11 may accommodate a substrate (not illustrated) to control the display 31, for example.

According to one aspect, it is possible to provide an electronic device of a novel structure which includes the display device attached to the support member in more accurate position and can prevent the display device from being damaged at the time of attaching the display device to the support member.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device comprising:
a display comprising a first face, a second face opposite to the first face, and a lateral face extending between the first face and the second face;
a support member comprising:
a support face on which the first face is disposed, and
a projection that is spaced apart from the lateral face along the first face, the projection extends from the support face in a direction that intersects the support face; and
a fixing member comprising:
a first fixing part fixed to at least one of the second face and the lateral face, and
a second fixing part that faces the projection along the first face and that is fixed to the support member.

2. The electronic device according to claim 1, wherein
the first fixing part comprises a first cover that is connected to the second fixing part and that covers the lateral face.

3. The electronic device according to claim 2, wherein
the first fixing part comprises a second cover that is connected to the first cover and that covers the second face.

4. The electronic device according to claim 1, wherein
the lateral face comprises a plurality of lateral faces connected to one another,
the second fixing part comprises two second fixing parts disposed on two adjacent ones of the lateral faces, and
the first fixing part connects the two second fixing parts to each other.

5. The electronic device according to claim 1, wherein
the fixing member comprises the second fixing part bonded to the support face.

6. The electronic device according to claim 1, wherein
the fixing member comprises the second fixing part fixed to the support face with a screw.

7. The electronic device according to claim 6, further comprising
a substrate that controls the display, wherein
the lateral face comprises a plurality of lateral faces connected to one another,
the substrate projects from one of the plurality of lateral faces in a direction intersecting the one lateral face, and
the second fixing part fixed to the support face with the screw is disposed between the one lateral face and the projection.
